(19) United States
(12) Patent Application Publication
(10) Pub. No.: US 2007/0077414 A1
(43) Pub. Date: Apr. 5, 2007

(54) Light-scattering plastics composition having high brightness and use thereof in flat screens

(76) Inventors: Claus Rudiger, Krefeld (DE); Heinz Pudleiner, Krefeld (DE); Jurgen Rohner, Koln (DE); Tanja Gruter-Reetz, Krefeld (DE); Klaus Meyer, Dormagen (DE)

Correspondence Address: BAYER MATERIAL SCIENCE LLC, 100 BAYER ROAD, PITTSBURGH, PA, 15205, US

(21) Appl. No.: 11/542,392

(22) Filed: Oct. 3, 2006

(30) Foreign Application Priority Data
Oct. 5, 2005 (DE) 102005047615.5

(51) Int. Cl. B32B 5/16; C08F 283/00; B32B 27/36

(52) U.S. Cl. 428/323; 428/412; 525/461

(57) ABSTRACT

A thermoplastic molding composition suitable for the preparation of sheets, in particular for making diffuser sheets in flat screens is disclosed. The composition that contains 80 to 99.9% of a transparent thermoplastic material and 0.01 to 20% of scattering pigments in the form of polymeric particles having average particle diameter of 1 to 100 μm. is distinguished by a particularly low fines content of the scattering pigments.

### FIELD OF THE INVENTION

The invention relates to a thermoplastic molding composition and in particular to a composition containing transparent polymeric particles.

### TECHNICAL BACKGROUND OF THE INVENTION

Light-scattering translucent products of transparent plastics materials having various light-scattering additives, and moldings produced therefrom, are already known from the prior art.

For example, EP 634,445 discloses light-scattering compositions which comprise vinyl-acrylate-based polymeric particles having a core/shell morphology, in combination with TiO₂.

The use of light-scattering polycarbonate films in flat screens is described in U.S. 2004/0066645. Light-scattering pigments which are mentioned therein are polyacrylates (herein PC), PMMA polytetrafluoroethylenes, polyalkyltrialkoxysiloxanes and mixtures of these components.

JP 09311205 describes the use of PC/(poly(4-methyl-1-pentene) blends as matrix material for diffusers in backlight units.

JP 03078701 describes light-scattering. PC sheets which contain calcium carbonate and titanium dioxide as scattering pigments and which have a light-transmitting capacity of about 40%.

JP 05257002 describes light-scattering PC sheets having scattering pigments of silica.

JP 10046022 describes PC sheets having scattering pigments of polyorganosiloxanes.

JP 08220311 describes two-layer sheets having a coextruded diffuser layer of from 5 to 25 μm, which contains acrylic scattering pigments, and a base layer of thermoplastic resin. The scattering pigments used therein have a size of from 0.1 to 20 μm.

JP 10046018 describes a light diffusin plate that includes polycarbonate and 0.01 to 1% crosslinked, spherical acrylic resin.

JP 09011328 claims PC sheets having an embossed ribbed structure which is applied during extrusion.

JP 2004/029091 describes PC diffuser sheets which comprise from 0.3 to 20% scattering pigment and from 0.0005 to 0.1% optical brighteners.

EP 1,404,520 describes multi-layer sheets containing perfluoroalkylsulfonic acid salts as antistatic.

U.S. 2004/0228141 describes light-scattering PC films having thicknesses of from 0.025 to 0.5 mm which have been provided with antistatic properties, which PC films contain fluorinated phosphonium sulfonates as antistatics.

JP 11-005241 describes light-scattering sheets based on PMMA and comprising a base layer having inorganic scattering pigments and a transparent top layer having an antistatic.

The diffuser sheets known from the prior art have unsatisfactory brightness, in particular in conjunction with the set of films conventionally used in a so-called backlight unit. In order to assess the suitability of the light-scattering sheets for such backlight units for LCD flat screens, the brightness of the system as a whole must be considered.

In principle, a backlight unit (direct light system) has the structure described below. It generally includes a housing in which, depending on the size of the backlight unit, a plurality of fluorescent tubes, so-called CCFLs (cold cathode fluorescent lamp), are arranged. The inside of the housing is equipped with a light-reflecting surface. The diffuser sheet, which has a thickness of from 1 to 3 mm, preferably a thickness of from 1.5 to 2 mm, is disposed on this lighting system. On the diffuser sheet there is located a set of films, which may have the following functions: light scattering (diffuser films), circular polarizers, focusing of the light in the forward direction by so-called BEF (brightness enhancing film) and linear polarizers. The linear polarizing film is situated directly beneath the LCD display located above it.

Light-scattering plastics compositions for optical applications conventionally always comprise inorganic or organic particles having a diameter of from 1 to 50 micrometres, in some cases even up to 120 μm, i.e. they contain scattering centres which are responsible for both the diffusive and the focusing properties.

According to the prior art any acrylates that have sufficiently high thermal stability at least up to 300° C. may be used as transparent scattering pigments. In addition, pigments must not have any functionalities that lead to degradation of the polymeric chain of the plastics material.

Suitable scattering pigments include core-shell acrylates such as Paraloid® from Rohm & Haas and Techpolymer® from Sekisui. A large number of different types are available from these product lines. Preference is given to the use of core-shell acrylates from the Paraloid group.

Particles having sizes from 1 to 50 μm are particularly suitable for the light scattering of light having wavelengths of from 350 to 800 nm. Nano-scale particles from 10 to 200 nm in size make a negligible contribution to light scattering and should therefore play a negligible role in the optical properties.

### SUMMARY OF THE INVENTION

A thermoplastic molding composition suitable for the preparation of sheets, in particular for making diffuser sheets in flat screens is disclosed. The composition that contains 80 to 99.9% of a transparent thermoplastic material and 0.01 to

20% of scattering pigments in the form of polymeric particles having an average particle diameter of 1 to 100 μm is distinguished by a particularly low fines content of the scattering pigments.

### DETAILED DESCRIPTION OF THE INVENTION

It has now been surprisingly found that polymeric, preferably polycarbonate, sheets made from compositions that contain a particularly small amount of nano-scale particles in addition to the normal μm-sized scattering particles of the core-shell acrylates exhibit surprisingly high luminance in the BLUs while showing the same degree of light scattering. This effect is even more evident in conjunction with the set of films typically used in a backlight unit (BLU).

There is no evidence that the art has thus far recognized the nano-scale phase according to the present invention or the importance of these particles for the optical properties of the plastics composition according to the invention.

As has now, surprisingly, been found, the content of particles having a mean particle diameter of from 80 to 200 nm has a particularly adverse effect on the luminance of the diffuser sheet in the BLU, even though these particles do not have any effect on the scattering action, which is expressed in terms of haze.

This invention accordingly provides a thermoplastic composition and diffuser sheets produced therefrom which contain transparent polymeric particles having a refractive index that is different from that of the matrix material and which are characterised in that the content of nano-scale particles having a mean particle diameter of from 80 to 200 nm is less than 20 particles per 100 μm² surface area of the plastics composition, preferably less than 10 particles per 100 μm², particularly preferably less than 5 particles per 100 μm².

The number of particles per surface area is determined by atomic force microscopy (AFM). This method is known to the person skilled in the art and is described in greater detail in the examples.

A preferred embodiment of the invention is a plastics composition that comprises a composition comprising from 80 to 99.99 wt. % of a transparent plastics material, preferably polycarbonate, and from 0.01 to 20 wt. % polymeric particles, the polymeric particles having a particle size of from 1 to 50 μm, characterised by a content of particles having a particle size of from 80 to 200 nm of less than a value of 20 particles per 100 μm² surface area of the plastics composition, preferably less than 10 particles per 100 μm², particularly preferably less than 5 particles per 100 μm².

This invention further provides a process for the preparation of the plastics composition according to the invention.

The plastics compositions according to the invention are preferably prepared and processed further by thermoplastic processing. The nano-scale polymeric particles are formed by shear during the thermoplastic processing. Core/shell acrylates are preferably used, however, on account of their morphology, because they yield the plastics compositions according to the invention.

This invention relates also to the use of the plastics composition according to the invention in the production of sheets, especially diffuser sheets for flat screens, in particular in the backlighting of LCD displays.

The diffuser sheets produced from the plastics compositions according to the invention have high light transmission while at the same time having a high degree of light scattering, and they may be used, for example, in the lighting systems of flat screens (LCD screens), where a high degree of light scattering with, at the same time, high light transmission and focusing of the light in the direction towards the viewer is of critical importance. The lighting system of such flat screens may be effected either with lateral light input (edge light system) or, in the case of larger screen sizes, where lateral light input is not sufficient, by means of a backlight unit (BLU), in which the direct lighting behind the diffuser sheet must be distributed as uniformly as possible by the diffuser sheet (direct light system).

Suitable plastics materials are any transparent thermoplastics: polyacrylates, polymethacrylates (PMMA; Plexiglas® from Röhm), cycloolefin copolymers (COC; Topas® from Ticona; Zenoex® from Nippon Zeon or Apel® from Japan Synthetic Rubber), polysulfones (Ultrason® from BASF or Udel® from Solvay), polyesters, for example PET or PEN, polycarbonate, polycarbonate/polyester blends, e.g. PC/PET, polycarbonate/polycyclohexylmethanolcyclo-hexanedicarboxylate (PCCD; Xylecs® from GE), polycarbonate/PBT.

Preference is given to the use of polycarbonates.

Suitable polycarbonates for the preparation of the plastics composition according to the invention are any known polycarbonates. These include homopolycarbonates, copolycarbonates and thermoplastic polyester carbonates.

Suitable polycarbonates preferably have mean molecular weights M̅ w of from 18,000 to 40,000, preferably from 26,000 to 36,000 and especially from 28,000 to 35,000, determined by measuring the relative solution viscosity in dichloromethane or in mixtures of equal amounts by weight of phenol/o-dichlorobenzene calibrated by light scattering.

The preparation of the polycarbonates is preferably carried out by the interfacial process or the melt transesterification process and is described herein below using the example of the interfacial process.

The polycarbonates are prepared, inter alia, by the interfacial process. This process for polycarbonate synthesis is described many different times in the literature; reference may be made, by way of example, to H. Schnell, Chemistry and Physics of Polycarbonates, Polymer Reviews, Vol. 9, Interscience Publishers, New York 1964 p. 33 ff, Polymer Reviews, Vol. 10, “Condensation Polymers by Interfacial and Solution Methods”, Paul W. Morgan, Interscience Publishers, New York 1965, Chap. VII, p. 325, Dres. U. Grigo, K. Kircher and P.-R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, p. 118-145, and EP-A 0 517 044.

According to this process, the phosgenation of a disodium salt of an aromatic dihydroxy compound, preferably bisphenol (or of a mixture of different such compounds) which has been introduced into an aqueous-alkaline solution (or suspension) takes place in the presence of an inert organic solvent or solvent mixture, which forms a second phase. The resulting oligocarbonates, which are present mainly in the organic phase, are condensed with the aid of suitable catalysts to form high molecular weight polycarbonates dissolved in the organic phase. Finally, the organic phase is separated off and the polycarbonate is isolated therefrom by various working-up steps.

Examples of suitable aromatic dihydroxy compounds for the preparation of the polycarbonates to be used in accordance with the invention are hydroquinone, resorcinol, dihydroxydiphenyl, bis-(hydroxyphenyl)-alkanes, bis(hydroxyphenyl)-cycloalkanes, bis-(hydroxyphenyl) sulfides, bis-(hydroxyphenyl) ethers, bis-(hydroxyphenyl) ketones, bis-(hydroxyphenyl)-sulfones, bis-(hydroxy-phenyl) sulfoxides, α,α′-bis-(hydroxyphenyl)-diisopropylbenzenes and compounds thereof that are alkylated, alkylated in the ring and halogenated in the ring.

Preferred such compounds include 4,4′-dihydroxydiphenyl, 2,2-bis-(4-hydroxyphenyl)-1-phenyl-propane, 1,1-bis-(4-hydroxyphenyl)-phenyl-ethane, 2,2-bis-(4-hydroxyphenyl)propane, 2,4-bis-(4-hydroxyphenyl)-2-methylbutane, 1,3-bis-[2-(4-hydroxyphenyl)-2-propylbenzene (bisphenol M), 2,2-bis-(3-methyl-4-hydroxyphenyl)-propane, bis-(3,5-dimethyl4-hydroxyphenyl)-methane, 2,2-bis-(3,5-dimethyl-4-hydroxyphenyl)-propane, bis-(3,5-dimethyl-4-hydroxyphenyl)-sulfone, 2,4-bis-(3,5-dimethyl-4-hydroxyphenyl)-2-methylbutane, 1,3-bis-2-(3,5-dimethyl-4-hydroxyphenyl)-2-propyl]benzene, 1-bis-(4-hydroxyphenyl)-cyclohexane and 1,1-bis-(4-hydroxyphenyl)-3,3,5-trimethylcyclohexane (bisphenol TMC) and mixtures thereof.

Particularly preferred compounds are 4,4′-dihydroxydiphenyl, 1,1-bis-(4-hydroxyphenyl)-phenyl-ethane, 2,2-bis-(4-hydroxyphenyl)-propane, 2,2-bis(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane (bisphenol TMC) and mixtures thereof.

These and further suitable aromatic dihydroxy compounds are described, for example, in U.S. Pat. Nos. 2,999,835; 3,148,172; 2,991,273; 3,271,367; 4,982,014 and 2,999,846, in German Offenlegungsschriften 1,570,703; 2,063,050; 2,036,052; 2,211,956 and 3,832,396; French patent specification 1,561,518; in the monograph “H. Schnell, Chemistry and Physics of Polycarbonates, Interscience Publishers, New York 1964, p. 28ff; p. 102ff” and in “D. G. Legrand, J. T. Bendler, Handbook of Polycarbonate Science and Technology, Marcel Dekker New York 2000, p. 72ff”.

In the case of homopolycarbonates, only one aromatic dihydroxy compound is used, and in the case of copolycarbonates a plurality of such compounds is used, it being possible, of course, for these like all the other chemicals and auxiliary substances added to the synthesis, to be contaminated with the impurities from their own synthesis, handling and storage, although it is desirable to work with raw materials that are as clean as possible.

The monofunctional chain terminators required to adjust the molecular weight, such as phenol or alkylphenols, in particular phenol, p-tert.-butylphenol, isooctylphenol, cumylphenol, chlorocarbonic acid esters thereof or acid chlorides of monocarboxylic acids, or mixtures of these chain terminators, are either fed to the reaction with the bisphenolate or bisphenoloates or are added to the synthesis at any desired point in time, provided that phosgene or chlorocarbonic acid end groups are still present in the reaction mixture or, in the case of acid chlorides and chlorocarbonic acid esters as chain terminators, provided that sufficient phenolic end groups of the polymer that is forming are available. Preferably, however, the chain terminator(s) is/are added after the phosgenation at a location or at a time when no further phosgene is present but the catalyst has not yet been metered in, or they are metered in before the catalyst, together with the catalyst or in parallel thereto.

Any branching agents or branching agent mixtures that are to be used are added to the synthesis in the same manner, but usually before the chain terminators. Trisphenols, quaternary phenols or acid chlorides of tri- or tetra-carboxylic acids are conventionally used, or mixtures of the polyphenols or of the acid chlorides.

Examples of some compounds having three or more hydroxyl groups that may be used are
phloroglucinol,
4,6-dimethyl-2,4,6-tri-(4-hydroxyphenyl)-2-heptene,
4,6-dimethyl-2,4,6-tri-(4-hydroxyphenyl)-heptane,
1,3,5-tri-(4-hydroxyphenyl)-benzene,
1,1,1-tri-(4-hydroxyphenyl)-ethane,
tri-(4-hydroxyphenyl)-phenylmethane,
2,2-bis-(4,4-bis-(4-hydroxyphenyl)-cyclohexyl]-propane,
2,4-bis-(4-hydroxyphenyl-isopropyl)-phenol,
tetra-(4-hydroxyphenyl)-methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole.

Preferred branching agents are 3,3-(bis(3-methyl-4-hydroxyphenyl)-2-oxo-2,3-dihydroindole and 1,1,1-tri-(4-hydroxyphenyl)-ethane.

The catalysts used in the interfacial synthesis are tertiary amines, in particular triethylamine, tributylamine, trioctylamine, N-ethylpiperidine, N-methylpiperidine, N-i/n-propylpiperidine; quaternary ammonium salts such as tetrabutylammonium/tributylbenzylammonium/tetraethylammonium hydroxide/chloride/bromide/hydrogen sulfate/tetrafluoroborate; and also the phosphonium compounds corresponding to the ammonium compounds. These compounds, as typical interfacial catalysts, are described in the literature, are available commercially and are known to the person skilled in the art. The catalysts may be added to the synthesis individually, in a mixture or simultaneously and in succession, optionally also before the phosgenation, but preference is given to metered additions after the introduction of the phosgene, unless an onium compound or mixtures of onium compounds are being used as catalysts, in which case it is preferred to add the catalyst before the phosgene is metered in. The catalyst or catalysts may be metered in without a solvent, in an inert solvent, preferably the solvent used in the polycarbonate synthesis, or in the form of an aqueous solution, in the case of the tertiary amines in the form of their ammonium salts with acids, preferably mineral acids, especially hydrochloric acid. When a plurality of catalysts are used, or when partial amounts of the total amount of catalyst are metered in, it is of course possible to use different metering methods at different locations or at different times. The total amount of catalysts used is from 0.001 to 10 mol. %, based on moles of bisphenols used, preferably from 0.01 to 8 mol. %, particularly preferably from 0.05 to 5 mol. %.

It is also possible to prepare polycarbonates from diaryl carbonates and diphenols according to the known polycarbonate process in the melt, the so-called melt transesterification process, which is described, for example, in WO-A 01/05866 and WO-A 01/05867. In addition, transesterification processes (acetate process and phenyl ester process) are described, for example, in U.S. Pat. No. 3,494,885; 4,386,186; 4,661,580; 4,680,371 and 4,680,372; in EP 26,120; 26,121; 26,684; 28,030; 39,845; 39,845; 91,602; 97,970; 79,075; 146,887; 156,103; 234,913 and 240,301 as well as in DE 1,495,626 and 2,232,977.

Both homopolycarbonates and copolycarbonates are suitable. For the preparation of copolycarbonates according to the invention as component A it is also possible to use from 1 to 25 wt. %, preferably from 2.5 to 25 wt. % (based on the total amount of diphenols to be used), of polydiorganosiloxanes having hydroxy-aryloxy end groups. These are known (see, for example, U.S. Pat. No. 3,419,634) or may be prepared by processes known in the literature. The preparation of copolycarbonates containing polydiorganosiloxanes is described, for example, in DE 3,334,782.

Preferred polycarbonates, in addition to the homopolycarbonates of bisphenol A, are the copolycarbonates of bisphenol A with up to 15 mol. %, based on the molar sums of diphenols, of diphenols other than those mentioned as being preferred or particularly preferred, in particular 2,2-bis(3,5-dibromo-4-hydroxyphenyl)-propane, 1,3-dihydroxybenzene.

Also suitable are polyester carbonates and block copolyester carbonates, in particular as described in WO 2000/26275. Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

Particular preference is given to mixtures of the diacid dichlorides of isophthalic acid and terephthalic acid in a ratio of from 1:20 to 20:1.

In the preparation of polyester carbonates, a carbonic acid halide, preferably phosgene, is additionally used concomitantly as bifunctional acid derivative.

As chain terminators for the preparation of the aromatic polyester carbonates there come into consideration, in addition to the monophenols already mentioned, also the chlorocarbonic acid esters thereof and the acid chlorides of aromatic monocarboxylic acids, which may optionally be substituted by C1-C22-alkyl groups or by halogen atoms, as well as aliphatic C2-C22-monocarboxylic acid chlorides.

The amount of chain terminators is in each case from 0.1 to 10 mol. %, based in the case of the phenolic chain terminators on moles of diphenols and in the case of monocarboxylic acid chloride chain terminators on moles of dicarboxylic acid dichlorides.

The aromatic polyester carbonates may also contain aromatic hydroxycarboxylic acids incorporated therein.

The aromatic polyester carbonates may be branched both linearly and in a known manner (see in this respect also DE 2,940,024 and DE 3,007,934).

Examples of suitable branching agents include carboxylic acid chlorides having a functionality of 3 or more, such as trimesic acid trichloride, cyanuric acid trichloride, 3,3′-4,4′-benzophenonetetra-carboxylic acid tetrachloride, 1,4,5,8-naphthalenetetracarboxylic acid tetrachloride or pyromellitic acid tetrachloride, in amounts of from 0.01 to 1.0 mol. % (based on dicarboxylic acid dichlorides used) or phenols having a functionality of 3 or more, such as phloroglucinol, 4,6-dimethyl-2,4,6-tri-(4-hydroxyphenyl)-2,4,4-heptene, dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenyl-methane, 2,2-bis[4,4-bis(4-hydroxyphenyl)cyclohexyl]-propane, 2,4-bis-(4-hydroxyphenyl-isopropyl)-phenol, tetra-(4-hydroxyphenyl)-methane, 2,6-bis-(2-hydroxy-5-methyl-benzyl)-4-methylphenol, 2-(4-hydroxyphenyl)-2-(2,4-dihydroxyphenyl)-propane, tetra-(4-[4-hydroxyphenyl-isopropyl]-phenoxy)-methane, 1,4-bis-[4,4′-dihydroxytriphenyl)-methyl]-benzene, in amounts of from 0.01 to 1.0 mol. %, based on diphenols used. Phenolic branching agents may be placed in a vessel with the diphenols, acid chloride branching agents may be introduced together with the acid dichlorides.

The proportion of carbonate structural units in the thermoplastic, aromatic polyester carbonates may vary as desired.

The proportion of carbonate groups is preferably up to 100 mol. %, in particular up to 80 mol. %, particularly preferably up to 50 mol. %, based on the sum of ester groups and carbonate groups.

Both the esters and the carbonates contained in the aromatic polyester carbonates may be present in the polycondensation product in the form of blocks or in randomly distributed form.

The relative solution viscosity (eta rel) of the aromatic polyester carbonates is in the range from 1.18 to 1.4, preferably from 1.22 to 1.3 (measured on solutions of 0.5 g of polyester carbonate in 100 ml of methylene chloride solution at 25 DEG C.).

The thermoplastic, aromatic polycarbonates and polyester carbonates may be used alone or in any desired mixture with one another.

Copolycarbonates within the scope of the invention are in particular polydiorganosiloxane-polycarbonate block copolymers having a mean molecular weight Mw of approximately from 10,000 to 200,000, preferably from 20,000 to 80,000 (determined by gel chromatography after previous calibration) and having a content of aromatic carbonate structural units of approximately from 75 to 97.5 wt. %, preferably from 85 to 97 wt. %, and a content of polydiorganosiloxane structural units of approximately from 25 to 2.5 wt. %, preferably from 15 to 3 wt. %, the block copolymers being prepared from polydiorganosiloxanes containing alpha,omega-bishydroxyaryloxy end groups and having a degree of polymerization (Pn) of 5 to 100, preferably 20 to 80.

The polydiorganosiloxane-polycarbonate block polymers may also be a mixture of polydiorganosiloxane-polycarbonate block copolymers with conventional polysiloxane-free, thermoplastic polycarbonates, the total content of polydiorganosiloxane structural units in this mixture being approximately from 2.5 to 25 wt. %.

Such polydiorganosiloxane-polycarbonate block copolymers are characterised in that they contain in the polymer chain on the one hand aromatic carbonate structural units (1) and on the other hand polydiorganosiloxanes containing aryloxy end groups (2).

Such polydiorganosiloxane-polycarbonate block copolymers are known, for example, from U.S. Pat. Nos. 3,189,662; 3,821,325 and 3,832,419.

Preferred polydiorganosiloxane-polycarbonate block copolymers are prepared by reacting polydiorganosiloxanes containing alpha,omega-bishydroxyaryloxy end groups together with other diphenols, optionally with the concomitant use of branching agents in the conventional amounts, for example according to the two-phase interfacial process (see in this respect H. Schnell, Chemistry and Physics of Polycarbonates Polymer Rev. Vol. IX, page 27 ff, Interscience Publishers New York 1964), the ratio of the bifunctional phenolic reactants being so chosen that the content according to the invention of aromatic carbonate structural units and diorganosiloxy units results therefrom.

Such polydiorganosiloxanes containing alpha,omega-bishydroxyaryloxy end groups are known, for example, from U.S. Pat No. 3,419,634.

The acrylate-based polymeric particles having core-shell morphology that are to be used in accordance with the invention are, for example and preferably, those as disclosed in EP 634,445.

The polymeric particles have a core of a rubber-like vinyl polymer. The rubber-like vinyl polymer may be a homo- or co-polymer of any desired monomer that possesses at least one ethylene-like unsaturated group and is known to the person skilled in the field to enter into addition polymerization under the conditions of emulsion polymerization in an aqueous medium. Such monomers are listed in U.S. Pat. No. 4,226,752, column 3, lines 40 to 62.

The rubber-like vinyl polymer preferably comprises at least 15%, more preferably at least 25%, most preferably at least 40%, of a polymerized acrylate, methacrylate, monovinylarene or optionally substituted butadiene and from 0 to 85%, more preferably from 0 to 75%, most preferably from 0 to 60%, of one or more copolymerized vinyl monomers, based on the total weight of the rubber-like vinyl polymer.

Preferred acrylates and methacrylates are alkyl acrylates or alkyl methacrylates which contain preferably from 1 to 18, particularly preferably from 1 to 8, most preferably from 2 to 8, carbon atoms in the alkyl group, such as methyl, ethyl, n-propyl, isopropyl, n-butyl, sec.-butyl or tert.-butyl or hexyl, heptyl or octyl groups. The alkyl group may be linear or branched. Preferred alkyl acrylates are ethyl acrylate, n-butyl acrylate, isobutyl acrylate or 2-ethylhexyl acrylate. The most preferred alkyl acrylate is butyl acrylate.

Examples of other suitable acrylates are 1,6-hexanediol diacrylate, ethylthioethyl methacrylate, isobornyl acrylate, 2-hydroxyethyl acrylate, 2-phenoxyethyl acrylate, glycidyl acrylate, neopentyl glycol diacrylate, 2-ethoxyethyl acrylate, tert.-butylaminoethyl methacrylate, 2-methoxyethyl acrylate, glycidyl methacrylate and benyl methacrylate.

Preferred monovinylarenes are styrene or α-methylstyrene, optionally substituted on the aromatic ring by an alkyl group, such as methyl, ethyl or tert.-butyl, or by a halogen, such as chlorostyrene.

If substituted, the butadiene is preferably substituted by one or more alkyl groups containing from 1 to 6 carbon atoms or by one or more halogens, most preferably by one or more methyl groups and/or one or more chlorine atoms. Preferred butadienes are 1,3-butadiene, isoprene, chlorobutadiene and 2,3-dimethyl-1,3-butadiene.

The rubber-like vinyl polymer may comprise one or more (co)polymerized acrylates, methacrylates, monovinylarenes and/or optionally substituted butadienes. These monomers may be copolymerized with one or more other copolymerizable vinyl polymers, such as diacetoneacrylamide, vinylnaphthalene, 4-vinylbenzyl alcohol, vinyl benzoate, vinyl propionate, vinyl caproate, vinyl chloride, vinyl oleate, dimethyl maleate, maleic anhydride, dimethyl fumarate, vinylsulfonic acid, vinylsulfonamide, methyl vinylsulfonate, N-vinylpyrrolidone, vinylpyridine, divinylbenzene, vinyl acetate, vinyl versatate, acrylic acid, methacrylic acid, N-methylmethacrylamide, acrylonitrile, methacrylonitrile, acrylamide or N-(isobutoxymethyl)-acrylamide.

One or more of the above-mentioned monomers has optionally been reacted with from 0 to 10%, preferably from 0 to 5%, of a copolymerizable, polyfunctional crosslinker and/or with from 0 to 10%, preferably from 0 to 5%, of a copolymerizable polyfunctional graft crosslinker, based on the total weight of the core. If a crosslinking monomer is used, it is preferably used with a content of from 0.05 to 5%, more preferably from 0.1 to 1%, based on the total weight of the core monomers. Crosslinking monomers are well known in the specialist field and they generally have a polyethylene-like unsaturation, in which the ethylene-like unsaturated groups have approximately equal reactivity, such as divinylbenzene, trivinylbenzene, 1,3- or 1,4-triol acrylates or methacrylates, glycol di- or tri-methacrylates or acrylates, such as ethylene glycol dimethacrylate or diacrylate, propylene glycol dimethacrylate or diacrylate, 1,3- or 1,4-butylene glycol dimethacrylate or, most preferably, 1,3- or 1,4-butylene glycol diacrylate. If a graft-crosslinking monomer is used, it is preferably used with a content of from 0.1 to 5%, more preferably from 0.5 to 2.5%, based on the total weight of the core monomers. Graft-crosslinking monomers are well known in the specialist field, and they are generally polyethylene-like unsaturated monomers which have sufficiently low reactivity of the unsaturated groups so that significant residual unsaturation is possible, which remains in the core following its polymerization. Preferred graft crosslinkers are copolymerizable allyl, methallyl or crotyl esters of α,β-ethylene-like unsaturated carboxylic acid or dicarboxylic acids, such as allyl methacrylate, allyl acrylate, diallyl maleate and allylacryloxy propionate, most preferably allyl methacrylate.

Most preferably, the polymeric particles contain a core of rubber-like alkyl acrylate polymer, wherein the alkyl group has from 2 to 8 carbon atoms, optionally copolymerized with from 0 to 5% crosslinker and from 0 to 5% graft crosslinker, based on the total weight of the core. The rubber-like alkyl acrylate has preferably been copolymerized with up to 50% of one or more copolymerizable vinyl monomers, for example those mentioned above. Suitable crosslinking and graft-crosslinking monomers are well known to the person skilled in the field, and they are preferably those as described in EP 269,324.

The core of the polymeric particles may contain residual oligomeric material that was used in the polymerization process to swell the polymer particles, but such an oligomeric material has a sufficient molecular weight to prevent its diffusion or to prevent it from being extracted during processing or use.

The polymeric particles contain one jacket (shell or superstrate) or a plurality of jackets. This one jacket or this plurality of jackets has preferably been prepared from a vinyl homo- or co-polymer. Suitable monomers for the preparation of the jacket(s) are listed in U.S. Pat. No. 4,226,752, column 4, lines 20 to 46, reference being made to the information given therein. A jacket or a plurality of jackets is preferably a polymer of a methacrylate, acrylate, vinylarene, vinyl carboxylate, acrylic acid and/or methacrylic acid.

Preferred acrylates and methacrylates are alkyl acrylates or alkyl methacrylates which preferably contain from 1 to 18, particularly preferably from 1 to 8, most preferably from 2 to 8, carbon atoms in the alkyl group, such as methyl, ethyl, n-propyl, isopropyl, n-butyl, isobutyl or tert.-butyl, 2-ethylhexyl or the hexyl, heptyl or octyl groups. The alkyl group may be linear or branched. The preferred alkyl acrylate is ethyl acrylate. Other acrylates and methacrylates which may be used are those mentioned hereinbefore for the core, preferably 3-hydroxypropyl methacrylate. The most preferred alkyl methacrylate is methyl methacrylate.

Prefered vinylarenes are styrene or a-methylstyrene, optionally substituted on the aromatic ring by an alkyl group, such as methyl, ethyl or tert.-butyl, or by a halogen, such as chlorostyrene.

A preferred vinyl carboxylate is vinyl acetate.

The jacket/jackets preferably comprise(s) at least 15%, more preferably at least 25%, most preferably at least 40%, of a polymerized methacrylate, acrylate or monovinylarene and from 0 to 85%, more preferably from 0 to 75%, most preferably from 0 to 60%, of one or more vinyl comonomers, such as other alkyl methacrylates, aryl methacrylates, alkyl acrylates, aryl acrylates, alkyl- and aryl-acrylamides, acrylonitrile, methacrylonitrile, maleimide and/or alkyl and aryl acrylates and methacrylates, which are substituted by one or more substituents, such as halogen, alkoxy, alkylthio, cyanoalkyl or amino. Examples of suitable vinyl comonomers have been given hereinbefore. Two or more monomers may be copolymerized.

The jacket polymer may comprise a crosslinker and/or a graft crosslinker of the type indicated above with reference to the core polymer.

The jacket polymers account for preferably from 5 to 40%, more preferably from 15 to 35%, of the total particle weight.

The polymeric particles comprise at least 15%, preferably from 20 to 80%, more preferably from 25 to 60%, most preferably from 30 to 50%, of a polymerized alkyl acrylate or methacrylate, based on the total weight of the polymer. Preferred alkyl acrylates and methacrylates have been indicated hereinbefore. The alkyl acrylate or alkyl methacrylate constituent may be present in the core and/or in the jacket/jackets of the polymeric particles. Homopolymers of an alkyl acrylate or methacrylate in the core and/or the jacket/jackets may be used, but an alkyl (meth)acrylate is preferably copolymerized with one or more other types of alkyl (meth)acrylates and/or one or more other vinyl polymers, preferably with those listed above. Most preferably, the polymeric particles comprise a core of a poly(butyl acrylate) and a jacket or a plurality of jackets of poly(methyl methacrylate).

The polymeric particles may be used to impart light-scattering properties to the transparent plastics material, preferably polycarbonate. The refractive index n of the core and of the jacket/jackets of the polymeric particles is preferably within

+/−0.25 unit, more preferably within +/−0.18 unit, most preferably within +/−0.12 unit, of the refractive index of the polycarbonate. The refractive index n of the core and of the jacket/jackets is preferably not closer than +/−0.003 unit, more preferably not closer than +/−0.01 unit, most preferably not closer than +/−0.05 unit, to the refractive index of the polycarbonate. The refractive index is measured in accordance with standard ASTM D 542-50 and/or DIN 53 400. Accordingly, if a matrix other than polycarbonate is used, the same differences in units of refractive index are preferred.

The polymeric particles generally have an average particle diameter of at least 0.5 micrometre, preferably at least 2 micrometres, more preferably from 2 to 50 micrometres, most preferably from 2 to 15 micrometres. The expression “average particle diameter” is to be understood as meaning the number average. Preferably at least 90%, most preferably at least 95%, of the polymeric particles have a diameter of more than 2 micrometres. The polymeric particles are a free-flowing powder, preferably in compacted form.

The polymeric particles may be prepared in a known manner. In general, at least one monomer component of the core polymer is subjected to emulsion polymerization with the formation of emulsion polymer particles. The emulsion polymer particles are swelled with the same or with one or more different monomer components of the core polymer, and the monomer/monomers is/are polymerized within the emulsion polymer particles. The steps of swelling and polymerization may be repeated until the particles have grown to the desired core size. The core polymer particles are suspended in a second aqueous monomer emulsion, and a polymer jacket of the monomer/monomers is polymerized onto the polymer particles in the second emulsion. One jacket or a plurality of jackets may be polymerized onto the core polymer. The preparation of core/jacket polymer particles is described in EP 269,324 and in U.S. Pat. No. 3,793,402 and 3,808,180.

It has further been shown, surprisingly, that the use of a small amount of optical brighteners enables the brightness values to be increased further.

An embodiment of the invention is accordingly constituted by a plastics composition according to the invention that may additionally comprise from 0.001 to 0.2 wt. %, preferably approximately 1000 ppm, of an optical brightener of the class of the bis-benzoxazoles, phenylcoumarins or bis-styrylbiphenyls.

A particularly preferred optical brightener is Uvitex OB from Ciba Spezialitätenchemie.

The plastics compositions according to the invention may be prepared either by injection molding or by extrusion.

In the case of solid sheets having a large surface area, production by injection molding cannot be carried out economically for technical reasons. In such cases, the extrusion method is to be preferred For extrusion, polycarbonate granules are fed to the extruder and melted in the plasticising system of the extruder. The plastics melt is pressed through a sheet die and thereby shaped, is brought into the desired final form in the roll slit of a friction calender, and its shape is fixed by alternate cooling on smoothing rollers and in the ambient air. The polycarbonates having high melt viscosity that are used for the extrusion are conventionally processed at melting temperatures of from 260 to 320° C., and the cylinder temperatures of the plasticising cylinder and the die temperatures are adjusted accordingly.

By using one or more lateral extruders and suitable melt adaptors upstream of the sheet die it is possible to place polycarbonate melts having different compositions above one another and accordingly produce multi-layer sheets or films (see, for example, EP 110,221 and EP 110,238).

Both the base layer of the molded bodies according to the invention and the coextruded layer(s) which is/are optionally present may additionally comprise additives, such as, for example, UV absorbers and other conventional processing aids, in particular mold release agents and flow agents, as well as the stabilizers conventional for polycarbonates, in particular heat stabilizers, as well as antistatics, optical brighteners. Different additives or concentrations of additives may be present in each layer.

In a preferred embodiment, the composition of the solid sheet additionally comprises from 0.01 to 5 wt. % of a UV absorber from the class of the benzotriazole derivatives, dimeric benzotriazole derivatives, triazine derivatives, dimeric triazine derivatives, diaryl cyanoacrylates.

In particular, the coextruded layer may comprise UV absorbers and mold release agents.

Suitable stabilizers are, for example, phosphines, phosphites or Si-containing stabilizers and further compounds described in EP-A 0 500 496. Examples which may be mentioned include triphenyl phosphites, diphenylalkyl phosphites, phenyldialkyl phosphites, tris-(nonylphenyl) phosphite, tetrakis-(2,4-di-tert.-butylphenyl)-4,4′-biphenylene diphosphonate, bis(2,4-dicumylphenyl)pentaerythritol diphosphite and triaryl phosphite. Triphenylphosphine and tris-(2,4-di-tert.-butylphenyl) phosphite are particularly preferred.

Suitable mold release agents are, for example, the esters or partial esters of mono- to hexa-hydric alcohols, in particular of glycerol, of pentaerythritol or of guerbet alcohols.

Examples of monohydric alcohols are stearyl alcohol, palmityl alcohol and guerbet alcohols, an example of a dihydric alcohol is glycol, an example of a trihydric alcohol is glycerol, examples of tetrahydric alcohols are pentaerythritol and mesoerythritol, examples of pentahydric alcohols are arabitol, ribitol and xylitol, and examples of hexahydric alcohols are mannitol, glucitol (sorbitol) and dulcitol.

The esters are preferably the monoesters, diesters, triesters, tetraesters, pentaesters and hexaesters or mixtures thereof, in particular random mixtures, of saturated, aliphatic C₁₀- to C₃₆-monocarboxylic acids and optionally hydroxy-monocarboxylic acids, preferably with saturated, aliphatic C₁₄- to C₃₂-monocarboxylic acids and optionally hydroxy-monocarboxylic acids.

The commercially available fatty acid esters, in particular of pentaerythritol and of glycerol, may contain <60% different partial esters, owing to their preparation.

Saturated, aliphatic monocarboxylic acids having from 10 to 36 carbon atoms are, for example, capric acid, lauric acid, myristic acid, palmitic acid, stearic acid, hydroxystearic acid, arachic acid, behenic acid, lignoceric acid, cerotic acid and montanic acids.

Examples of suitable antistatics are cationic compounds, for example quaternary ammonium, phosphonium or sulfonium salts, anionic compounds, for example alkylsulfonates, alkyl sulfates, alkyl phosphates, carboxylates in the form of alkali or alkaline earth metal salts, non-ionic com- pounds, for example polyethylene glycol esters, polyethylene glycol ethers, fatty acid esters, eth- oxylated fatty amines. Preferred antistatics are non-ionic compounds.

The Examples which follow are intended to illustrate the invention without limiting it.

### EXAMPLES

The 2 mm solid sheets mentioned in Examples 1 and 2 were produced as follows:
1. Preparation of the compound using conventional twin-screw compounding extruders (e.g. ZSK 32) at processing temperatures conventional for polycarbonate of from 250 to 330° C.
2. The machines and apparatus used to produce the optionally coextruded 2 mm solid sheets include:
   the main extruder with a screw of length 33 D and a diameter of 70 mm, with degassing
   a coextruder for applying the top layer, with a screw of length 25 D and a diameter of 35 mm
   a special coextrusion sheet die having a width of 450 mm
   a friction calender
   a roller conveyor
   a take-off device
   a cutting device (saw) and a delivery table.

The polycarbonate granules of the base material were fed to the filling funnel of the main extruder. The material in question was melted and conveyed in the cylinder/screw plasticising system. The further devices were used to transport the extruded sheets, cut them to length and deposit them.

The polycarbonate used in the Examples described herein below was Makrolon® 3100 000000 polycarbonate resin, a product of Bayer MaterialScience AG.

### Example 1

A composition having the following composition was prepared:
polycarbonate in an amount of 98.7 wt. %
core-shell particles having a butadiene/styrene core and a methyl methacrylate shell Tech-polymer XX-03EJ with a particle size of from 2 to 15 μm and a mean particle size of 8 μm, in an amount of 1.2 wt. %
heat stabilizer triphenylphosphine in an amount of 0.1 wt. %.

A 2 mm solid diffuser sheet without a coextruded layer was extruded from this compound.

### Example 2

A compound having the following composition was prepared:
polycarbonate in an amount of 98.7 wt. %
core-shell particles having a butadiene/styrene core and a methyl methacrylate shell Paraloid EXL 5137 from Rohm & Haas with a particle size of from 2 to 15 μm and a mean particle size of 8 μm, in an amount of 1.2 wt. %
heat stabilizer triphenylphosphine in an amount of 0.1 wt. %.

A 2 mm solid diffuser sheet without a coextruded layer was extruded from this compound.

AFM Tests on Examples 1 and 2

The measurements were carried out using an atomic force microscope (AFM) from Digital Instruments.

The diffuser sheets produced in Examples 1 and 2 were evaluated for their content of nano-scale particles having a size of from 80 to 200 nm.

Three tests were carried out on two different samples of the diffuser sheets of Examples 1 and 2, in each case at different locations. The following is a summary of the results.

TABLE 1
Number of particles of 80 to 200 nm in an area of 10 × 10 μm²

| Sample | Diffuser sheet of Example 1 | Diffuser sheet of Example 2 (not |
|---|---|---|
| number | (according to the invention) | according to the invention) |
| 1a | 3 | 33 |
| 1b | 2 | 30 |
| 1c | 2 | 38 |
| 2a | 3 | 28 |
| 2b | 1 | 31 |
| 2c | 3 | 32 |
| Mean | 2 | 34 |
| Standard | 1 | 5 |
| deviation | | |

It is clear from the measurements that the diffuser sheet according to the invention contains significantly fewer particles having a particle size of from 80 to 200 nm.

Optical Investigations on Examples 1 and 2

The diffuser sheets of Examples 1 and 2 were tested for their optical properties according to the following standards and using the following measuring devices:

To determine the light transmission (Ty (D6510°)) and the light reflection (Ry (D6510°) over 10 white background) an Ultra Scan XE from Hunter Associates Laboratory, Inc. was used. In addition, the measurements to determine the yellowness index (YI (D65, C2°), ASTM E313), the x, y colour values (D65, C2°, CIE standard colour table) and the L, a, b colour values (D65, C2°, CIELAB colour system, DIN 6174) were carried out using this device. For the haze determination (according to ASTM D 1003), a Hazegard Plus device from Byk-Gardner was used.

The luminance measurements (brightness measurements) were carried out on a backlight unit (BLU) from DS LCD (LTA170WP, 17″ LCD TV panel) using a LS100 luminance meter from Minolta. The original diffuser sheet was removed from the unit and replaced by the 2 mm solid sheets produced in Examples 1 and 2.

TABLE 2
Optical measurement results

| | Example 1 | Example 2 |
|---|---|---|
| Ty[%](C2°) Hunter | 63.26 | 64.52 |
| Ultra Scan | | |
| Ry[%](C2°) Hunter | 75.77 | 72.85 |
| Ultra Scan | | |
| YI(C2°) | −14.47 | −12.20 |
| L*(C2°) | 83.58 | 84.24 |
| a*(C2°) | −0.59 | −0.46 |
| b*(C2°) | −6.24 | −5.34 |
| Haze[%] | 100 | 100 |
| brightness [cd/m2] without | 6100 | 6100 |
| films | | |
| brightness [cd/m2] with | 7850 | 7550 |
| films | | |

In the two Examples 1 and 2 listed in the table, the content of scattering pigments is constant. The scattering effect of the plates is comparable (haze=100%) and the base material used is also the same. It is most surprising that the diffuser plate of Example 1 initially exhibits the same luminance compared with Example 2 without the set of films that is conventionally used, but a clear advantage in the luminosity is detectable when the set of films is applied.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic molding composition comprising 80 to 99.9% of a transparent thermoplastic material and 0.01 to 20% of polymeric particles, said particles having an average particle diameter of 1 to 100 μm, provided that no more than 20 particles per 100 μm² surface area of the plastics composition have an average particle diameter of 80 to 200 nm as determined by atomic force microscopy, said percents, both occurrences being relative to the weight of the composition.

2. The composition according to claim 1, wherein the transparent thermoplastic material is polycarbonate.

3. A sheet having a thickness of from 1.0 to 4.0 mm comprising the composition according to claim 1.

4. A sheet having a thickness of from 1.0 to 4.0 mm comprising the composition according to claim 2.

5. The sheet of claim 3 further comprising having at least one additional layer produced by coextrusion.

6. The sheet of claim 5 wherein said at least one layer includes a UV absorber.

7. The sheet according to claim 5 wherein said at least one layer includes a lubricant.

8. The sheet according to claim 5 wherein additional layers number two and each is located on opposing sides of the sheet.

9. The sheet according to claim 8 wherein each coextruded layer has a thickness of 10 to 100 μm.

10. A diffuser sheet in flat screens comprising the composition of claim 1.

11. A thermoplastic molding composition comprising 80 to 99.9% of a transparent thermoplastic material and 0.01 to 20% of polymeric particles, said particles having an average particle diameter (also referred to as mean particle size) of 1 to 100 μm, provided that no more than 20 particles per 100 μm² surface area of the plastics composition have an average particle diameter of 80 to 200 nm as determined by atomic force microscopy, said percents, both occurrences being relative to the weight of the composition, said thermoplastic material and said particles differ one from the other in their respective refractive indices.
